(19) United States
(12) Patent Application Publication
(10) Pub. No.: US 2011/0108787 A1
(43) Pub. Date: May 12, 2011

(54) HOIST SYSTEM

(76) Inventors: DONALD A. THOMAS, Coraopolis, PA (US); Dennis O'Donnell, Pittsburgh, PA (US)

(21) Appl. No.: 12/943,403

(22) Filed: Nov. 10, 2010

Related U.S. Application Data
(60) Provisional application No. 61/259,716, filed on Nov. 10, 2009.

(51) Int. Cl. B66D 3/04; B66D 3/08

(52) U.S. Cl. 254/393; 254/390

(57) ABSTRACT

A hoist system may comprise a collapsible frame, a mounting mechanism, and a pulley mechanism. The mounting mechanism may secure the collapsible frame onto a tree. The pulley mechanism may be operably coupled to the collapsible frame to help pull a load up the tree.

### CROSS-REFERENCE TO RELATED APPLICATIONS

This application claims the benefit of priority to U.S. provisional patent application No. 61/259,716 filed Nov. 10, 2009, and incorporated herein by reference.

### BACKGROUND OF THE INVENTION

The present invention generally relates to a hoist system, and more particularly relates to a system that may be mounted up on a tree for hoisting equipment from down below the tree up to a user on the tree.

### SUMMARY OF THE INVENTION

In one aspect of the present invention, a hoist system comprises a collapsible frame; a mounting mechanism for securing the collapsible frame onto a tree; and a pulley mechanism operably coupled to the collapsible frame for pulling a load up the tree.

These and other features, aspects and advantages of the present invention will become better understood with reference to the following drawings, description and claims.

### BRIEF DESCRIPTION OF THE DRAWINGS

FIG. 1 shows a perspective view of a hoist system in accordance with an embodiment of the present invention;

FIG. 2 shows a side view of the hoist system of FIG. 1; and

FIG. 3 shows a side view of the hoist system of FIG. 1 in a folded position.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a hoist system that may be mounted on a tree without the need for a tree stand, for hoisting equipment from down below the tree up the tree. The hoist system may be useful to hunters to hoist their guns up a tree, or to a tree cutter to hoist his tree cutting equipment up a tree.

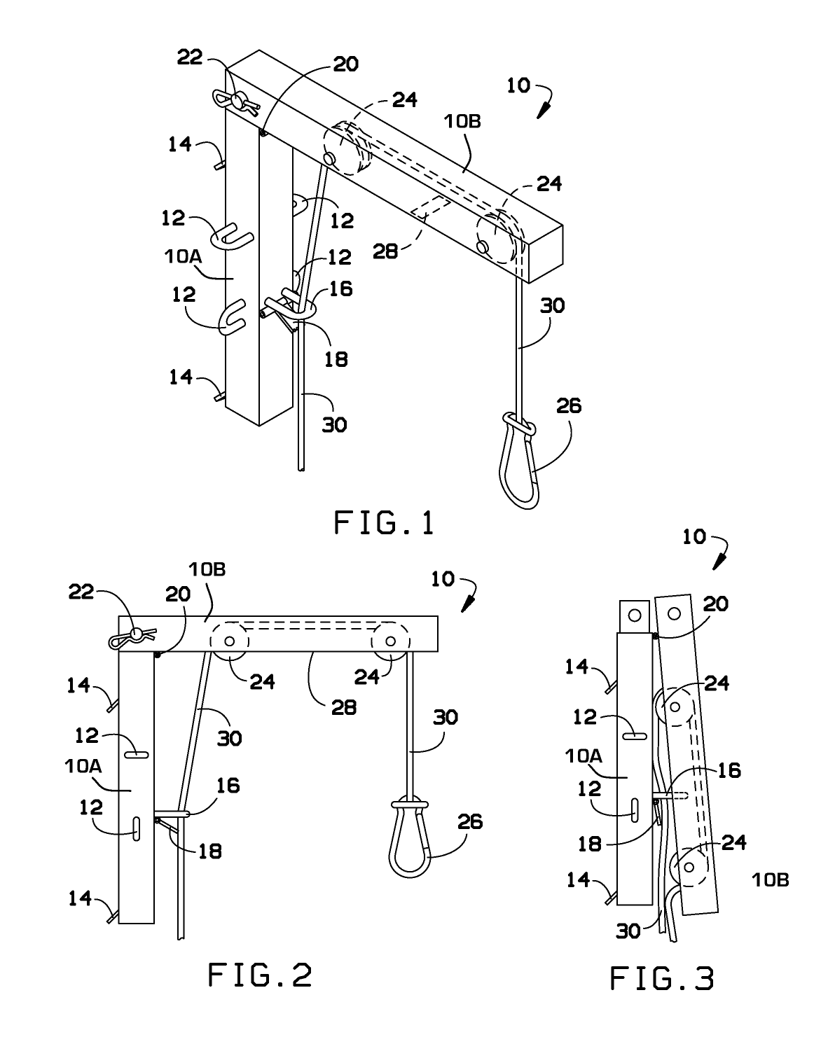

Referring now to FIGS. 1 and 2, the hoist system 10 may be a collapsible frame made up of a first leg 10A and a second leg 10B that may be made of steel. The first leg 10A and the second leg 10B may be connected via a hinge 20 that may be operably coupled to the first leg 10A and the second leg 10B. When the hoist system 10 is in an open position, the first leg 10A and the second leg 10B may form an L shape, where the first leg 10A is about perpendicular with the second leg 10B. A locking pin 22 may lock the hinge 20 into the open position to form the L shape when the hoist system 10 is in use. For example, if the hinge 20 is a pin that is inserted through hinged joints on the first and second legs 10A and 10B, the locking pin 22 may be a carter pin that may be fastened through the hinge 20.

The first leg 10A and the second leg 10B may each be a length of U channel. For example, the first leg 10A may be a length of U channel about fourteen inches in length and two inches in width and the second leg 10B may be a length of U channel about twelve inches in length and two inches in width. The legs 10A and 10B may also be operably coupled 10 to the hinge 20 in such a way so that the U channels of the first and second legs 10A and 10B may face each other.

The first leg 10A may have mounting mechanisms attached for mounting the hoist system 10 to a tree. The mounting mechanisms may include ratchet strap rings 12 that may connect to ratchet straps wrapped around the tree. The mounting mechanisms may also include tree-bark tines 14, such as four or more ½-inch tines, that may dig into the back of tree. When secured to the tree via the ratchet strap rings 12 and the tree-bark tines 14, the first leg 10A may be mounted so that it is about parallel with the trunk of the tree. Usually, that may mean that the first leg 10A is mounted about vertical, depending on the straightness of the trunk of the tree. The first leg 10A may also include a rope guide 16 and a rope locking mechanism 18 for controlling a rope 30, such as a 25-foot length of ¼-inch diameter rope, being used with the hoist system 10.

The second leg 10B may extend perpendicular to the first leg 10A away from near the top end of the first leg 10A when the hoist system 10 is locked into an open position, to form an L shape with the first leg 10A. A pulley mechanism including one or more pulleys 24 may be mounted within the length of U channel that makes up the second leg 10B. For example, each of the pulleys 24 may be mounted on an axle that straddles the two parallel walls of the U-channel. Optionally, the one or more pulleys 24 may include a groove to secure any ropes 30 running over the pulleys 24. The second leg 10B may also include a rope-feeding opening so that lengths of ropes 30 may be fed onto the pulleys 24.

In use, the hoist system 10 may be carried up a tree until it reaches a desired height. The hoist system 10 may be unlocked and the first leg 10A may be secured to the tree trunk by using the tree-bark tines 14 to dig into the tree and by securing ratchet straps around the trunk of the tree and securing those ratchet straps to the ratchet strap rings 12. Once connected to the ratchet strap rings 12, the ratchet straps may be tightened to tightly secure the first leg 10A to the tree.

A rope 30 may be fed through the rope-feeding access 28 so that it passes over the pulleys 24 on the second leg 10A. The rope 30 may be continually lowered from the second leg 10B until a user on a lower level, such as a person on the ground, may secure a load attachment 26 on the rope 30 to a desired load, such as by tying the load attachment 26 to a hunting rifle or a tree trimmer. The rope 30 may then be pulled by the upper user on the tree to hoist the load up the tree. The rope 30 may pass through the rope guide 16 and the rope locking mechanism 18 on the first leg 10A. When the load attached to the rope 30 is at a desired height, the rope locking mechanism 18 may be engaged to keep the rope 30 stationary. For example, the rope locking mechanism 18 may be engaged when the rope 30 is pulled in a down and outwards motion away from the first leg 10A and may be disengaged when the rope 30 is pulled in a down and inwards motion towards the first leg 10A. The rope guide 16 may help to keep the rope 30 near the first leg 10A, so that the rope is not blown away from the upper user by wind.

Referring now to FIG. 3, the hoist system 10 may be collapsed when not in use, thus making the hoist system 10 easier to store and transport. If the pulleys 24 on the second leg 10B protrudes out of the U channel of the second leg 10B, the U channel 10A may accept the protruding portions of the pulleys 24, allowing for the hoist system 10 to be as compact as possible when collapsed. Thus, it may be much less cumbersome to carry up a tree as the hoist system 10 may be carried in its collapsed state and may be opened only after the user has reached the desired tree height.

It should be understood, of course, that the foregoing relates to exemplary embodiments of the invention and that modifications may be made without departing from the spirit and scope of the invention as set forth in the following claims.

We claim:

1. A hoist system comprising:
a collapsible frame;
a mounting mechanism for securing the collapsible frame onto a tree; and
a pulley mechanism operably coupled to the collapsible frame for pulling a load up the tree.

2. The hoist system of claim 1, wherein the collapsible frame comprises a first leg and a second leg that are connected via a hinge.

3. The hoist system of claim 2, wherein the first leg and the second leg are about perpendicular to each other if the collapsible frame is in an open position.

4. The hoist system of claim 2, wherein the first leg comprises a first length of U channel and the second leg comprises a second length of U channel.

5. The hoist system of claim 4, wherein the pulley mechanism comprises one or more pulleys situated within an interior of the second length of U channel.

6. The hoist system of claim 2, wherein the mounting mechanism comprises ratchet strap rings on the first leg of the collapsible frame that are connectable to ratchet strap rings.

7. The hoist system of claim 6, wherein the mounting mechanism further comprises tines on the first leg of the collapsible frame for digging into the tree.

8. The hoist system of claim 3, wherein the first leg of the collapsible frame is securable to the tree via the mounting mechanism.

9. The hoist system of claim 8, wherein the second leg of the collapsible frame extends out away from the tree when the first leg of the collapsible frame is secured to the tree.

10. The hoist system of claim 3, further comprising a rope locking mechanism on the first leg of the collapsible frame.
